(19) United States
(12) Patent Application Publication
(10) Pub. No.: US 2003/0008090 A1
(43) Pub. Date: Jan. 9, 2003

(54) Plastic hollow body having an increased resistance to burning due to the provision of flameproofing agents

(76) Inventors: Wolfgang Rohde, Speyer (DE); Bernhard Springholz, Worms (DE); Shahram Mihan, Ludwigshafen (DE)

Correspondence Address: Keil & Weinkauf, 1101 Connecticut Ave NW, Washington, DC, 20036, US

(21) Appl. No.: 10/204,289

(22) PCT Filed: Feb. 14, 2001
(86) PCT No.: PCT/EP01/01606

(30) Foreign Application Priority Data
Feb. 24, 2000 (DE) 10008725.6

(51) Int. Cl. B32B 1/02

(52) U.S. Cl. 428/35.7

(57) ABSTRACT

A hollow plastic article with increased fire resistance is described, as are its use and a process for its production. The hollow plastic article has one or more layers made from polymeric material, of which at least one layer comprises flame retardants.

The present invention relates to hollow plastic articles with increased fire resistance, comprising one or more layers of polymeric material, where at least one layer has flame retardants.

The present invention further relates to the use of hollow plastic articles of this type with increased fire resistance as fuel tanks in automotive construction.

Hollow plastic articles for the storage and transport of hazardous liquids have been known for a long time. As well as being used for portable containers of all types, such as fuel canisters, plastic bottles for alcohols (methylated spirits), ethers and the like they are in particular used in the form of fuel tanks in motor vehicle construction, to save space and weight in the storage of gasoline or diesel fuels. In this area they have now almost completely replaced the heavier metal components.

Plastic fuel tanks (PFTs) are components which affect safety in an automobile and are subject to high fire resistance requirements. For the purpose of the present invention, the fire resistance here is the length of time for which a flame can be applied to a tank in which a liquid is present before holes appear in the tank wall and liquid is lost. These requirements are tested to ECE R34 Appendix 5 by a specific fire test. These test requirements are generally fulfilled firstly by using specific high-toughness polymer grades and secondly by complying with certain minimum wall thicknesses and therefore minimum weights for the plastic fuel tank. The optimum weight for a PFT here is the result of an optimization process relating to breaking strength and fire resistance. The fire resistance of the component often gives the lower limit for the weight of the PFT.

To increase the fire resistance of a PFT with a predetermined superficial shape it has hitherto been necessary to increase the tank wall thickness in the zones particularly at risk in the event of a fire, and this gives rise to a corresponding increase in weight. The production costs of the plastic fuel tank can be expected to rise with the increase in material consumption and cooling time. In addition, the usable volume of the tank reduces, and this is unacceptable in producing automobiles.

There is therefore a need for ways of reducing the weight of the tank for a given superficial shape, while complying with the requirements for the fire resistance of the component. There is also a constant search for ways of increasing fire resistance for a given weight and volume of tank.

EP 0 645 400 B1 describes polyethylene grades which inherently have increased flame retardancy, due to their specific product features. In this connection, the use of a specific ethylene polymer is disclosed for producing fire-resistant plastic fuel tanks. However, its preparation requires a two-stage process, composed of prepolymerization and main polymerization, and also highly specific catalysts. This process is inconvenient and expensive. The teaching of EP 645 400 is moreover that a large number of conditions have to be fulfilled simultaneously in order that plastic fuel tanks with increased fire resistance can be manufactured from the polyethylene material according to this patent specification. As can be seen from the examples which it presents, the combination of properties proposed in EP 645 400 B1 does not give any general assurance that the components it produces will have increased fire resistance.

U.S. Pat. No. 5,020,687 discloses plastic fuel tanks with reinforcing fabric inserts made from flame-retardant materials which foam when heated. However, these reinforcements have to be introduced into the blow mold in advance. This process, again, is inconvenient and expensive and can moreover lead to considerable losses of strength in the component.

It is also known, for example from EP A 106 099 or DE A 196 17 592, that plastic fuel tanks can be provided with flame-retardant coatings. DE 19 50 992 discloses a PFT which also has a metal foil coating. Coatings of this type are mostly very expensive, since they require additional processing steps. A further disadvantage is that the adhesion of coatings of this type to PE is low, and they can therefore delaminate in the event of an accident—precisely when it is essential that the layer is fully effective.

It has also been known for a long time that plastics can be provided with flame retardants. This serves primarily to reduce the combustibility of the organic material. Combustibility here has to be clearly distinguished from fire resistance. Combustibility is the term given to the behavior of gaseous, liquid or solid substances with respect to ignition: combustibility is present if a substance continues to burn after ignition, even when the ignition source is removed. The combustibility of a solid, in particular of a polymer, can be reduced or completely eliminated by flame retardants.

In contrast, the fire resistance of these PFTs is determined by a fire test, that is to say that a flame is applied to the tank under specified test conditions, and the time for a leak to arise is determined.

Flame retardants cannot affect the mere thermal action of the flame, which leads to heating and thus to softening or melting of the plastic. However, the thermal action of the flame is precisely the factor which has hitherto been given the greatest importance for describing the fire behavior of hollow plastic articles in which a liquid is present. The above-mentioned publications confirm this and show how insulating layers and, respectively, changes in the mechanical/rheological behavior of the materials of the component have been used precisely with the intention of reducing the thermal effect which the flame has on the material.

It is an object of the present invention, therefore, to provide hollow plastic articles whose structure has one or more layers and which have increased fire resistance, and also to provide a process for their production, while avoiding the disadvantages mentioned of the prior art.

A particular object of the present invention is to provide hollow plastic articles whose structure has one or more layers and which have increased fire resistance and which have low intrinsic weight together with adequate breaking strength and fire resistance.

We have found that this object is achieved by way of a hollow plastic article a hollow plastic article with increased fire reistance, comprising at least one opening, wherein the structure of the hollow plastic article has one or more layers and comprises at least one layer made from polymeric material and having flame retardants.

Advantageous embodiments are described in the dependent subclaims.

In light of the prior art described at the outset, it was surprising that flame retardants could have any detectable effect at all on the fire resistance of hollow articles made from plastics and in which a liquid is present.

Since flame retardants have an adverse effect on the mechanical properties of plastics, for example breaking strength, use of these in polymeric layers of hollow plastic articles has not been considered.

Surprisingly, however, it has been found that controlled use of flame retardants in a plastic composite having one or more layers can markedly raise the fire resistance of the hollow article, while the mechanical strength of the hollow article is unaffected or not significantly affected.

To give control and economy in introducing the flame retardant into the tank wall, the structure of the tank may have either one or more layers. In the case of tanks of single-layer structure, the flame retardant may be introduced in a controlled manner exclusively, or in a higher concentration, at the zones representing a particular fire-protection risk. One way of achieving this is to use a technique similar to visibility-strip extrusion, or else to use sequential coextrusion of the flame retardant with the tank wall polymer.

A tank wall structure which has more than one layer is particularly suitable for increasing economy in the use of flame retardants, since the particular action of the flame retardant is needed only on the outer surface, and this method can concentrate the flame retardant into this region.

It is preferable for the flame retardant to be introduced into the outer layers of a tank whose structure has more than one layer. This has the further advantage that the concentration of the flame retardant in the outer layers of a tank whose structure has more than one layer does not lead to any impairment of pinch-off welds or welded seams, which commonly occur in blow-molded tanks or in tanks composed of two half-shells.

It is particularly advantageous if the flame retardant has been added to a regrind layer, as frequently encountered in particular in coextrusion-blow-molded tanks, since the mechanical properties of the regrind layer are unimpaired, or not significantly impaired, by adding flame retardant, unlike those of base layers in which no regridn is present. The material of the regrind is composed of mixtures of suitable plastics. The regrind without flame retardants preferably comprises 50% by weight of the base material from which the supporting layers of the hollow article have been formed. In preferred embodiments, the regrind is mainly HDPE, together with typical barrier polymers, such as ethylene-vinyl alcohol copolymers, polyvinyl alcohol, polyester, polyamide, fluoropolymers (e.g. PTFE, PVDF), and also compatibilizers suitable for ensuring compatibility of the barrier polymer with the HDPE. Preferred barrier polymers are ethylene-vinyl alcohol copolymers, e.g. the commercially available grades EVAL® (Kuraray) and SOARNOL® (Elf Ato), and also polyamides (e.g. ULTRAMID®, BASF). Preferred compatibilizers are based on graft copolymers of maleic anhydride with HDPE, LLDPE or LDPE.

The proportion of the barrier polymer in the regrind layer is from 0.1 to 30% by weight, preferably from 1 to 20% by weight, in particular from 2 to 16% by weight. The proportion of compatibilizer in the regrind layer is from 0.1 to 50% by weight, preferably from 1 to 40% by weight, in particular from 4 to 20% by weight. The additions of flame retardant are not taken into account here.

The regrind layer is preferably produced from what is known as flash: residues of polymeric material arising, for example, during the production of the hollow plastic articles.

The layers of the novel hollow plastic articles, in particular the base layer, may be produced from any of the plastics usually used, for example from polyethylene, polypropylene, polyvinyl chloride, polyamide, polyketone, polyester or the like. Preference is given to polyethylene (PE), in particular high-density polyethylene (HDPE). HDPE is, inter alia, highly suitable for producing blow moldings by extrusion hollow articles.

The structure of the novel hollow articles preferably has at least two layers. Among these layers there is always a supporting base layer, which usually forms the inner surface of the hollow article. This layer is therefore of decisive significance for the imperviousness of the tank. The second layer and/or other layer(s) present in the novel tanks is a polymer layer near to the outer surface or actually forming the outer surface, and preferably composed to an extent of more than 50% of the material of the base layer, to which a flame retardant has been added. The layer comprising the flame retardant is particularly preferably a regrind layer.

There may be more than one other layer present in the tank wall between the base layer and the outermost layer. These may be barrier layers and/or tie layer which, if required, ensure bonding between the barrier layer and the base layer, and also bonding to the layer comprising the flame retardant.

Preferred barrier layers are those obtained by generating a layer using direct fluorination, surface-coating or plasma polymerization of the plastic tanks, or else those which can be introduced as a melt or film into the composite. The latter is successful with typical barrier plastics, such as polyamide or ethylene-vinyl alcohol copolymers.

One particularly preferred embodiment for a novel hollow article whose structure has more than one layer is given by a coextrusion-blow-molded 6-layer plastic fuel tank. The six layers comprise, in the direction from inside to outside:

HDPE/tie layer material/barrier polymer/tie layer material/regrind layer/HDPE. The thicknesses of these layers, in the same sequence and in each case based on the total thickness of the tank wall, are: HDPE from 10 to 40%; tie from 1 to 5%; barrier polymer from 1 to 10%; tie from 1 to 5%; regrind layer from 10 to 82%; HDPE from 5 to 30%. Particularly preferred layer thicknesses are as follows: HDPE from 20 to 40%, tie from 1 to 3%, barrier polymer from 1 to 3%, tie from 1 to 3%, regrind layer from 21 to 67%, HDPE from 10 to 30%. In this embodiment the flame retardant is preferably introduced into the regrind layer. However, any other desired combination of the above-mentioned plastic materials is possible in novel hollow articles having more than one layer, as determined by their required fire resistance and breaking strength.

The amount of flame retardant introduced into a particular layer, based on the total weight of the hollow plastic article, is from 1 to 25% by weight, preferably from 1 to 10% by weight, particularly preferably from 2 to 6% by weight.

To produce novel hollow plastic articles with increased fire resistance, the hollow plastic article is molded from a polymeric base layer and, if desired, other layers, preferably comprising a regrind layer, a tie layer and/or a barrier layer, and flame retardant is added to at least one layer, preferably the regrind layer, and the hollow plastic article is subjected, if desired, to a heat treatment at from 60 to 135° C.

The novel hollow article is in particular produced by extrusion blow molding, injection molding or thermoforming. In the two last-named methods, two tank half-shells have to be produced and welded together. Blow molding is preferred. Particular preference is given to coextrusion blow molding, where if any regrind layers are present the flame retardant is incorporated into the regrind layers.

Partial, rather than uniform, introduction of the flame retardant into a layer of a multilayer composite is also possible in principle. This can further reduce costs and the adverse effect of the flame retardant on the mechanical properties of the component. In the case of blow molding, this partial introduction of the flame retardant can take place by way of additional extruders, in a manner similar to visibility-strip extrusion and/or to sequential coextrusion.

In the case of tanks whose structure has more than one layer, the same retardant is incorporated in one or more of the outer layers. This has the particular advantage that the mechanical properties relevant to breakage are essentially determined by the supporting innermost layer, whereas, usefully, the outer layers are the decisive factor affecting fire resistance properties.

Especially when polyethylene is used, a further improvement in the mechanical properties can be achieved by annealing the components at from 60-135° C. for periods of from 0.25 to 30 hours.

Flame retardants suitable according to the invention are any inorganic and/or organic substances which when added to plastics of any kind render these nonflammable, hinder their ignition and inhibit, or completely prevent, their combustion. Examples of these are:

Halogenated, in particular bromine-containing, organic compounds;

antimony-containing flame retardants, particularly preferably the combination of antimony trioxide with halogen-containing flame retardants;

phosphorus-containing flame retardants, including halogenated organic phosphorus compounds;

specific inorganic flame retardants, such as aluminum hydroxide, magnesium hydroxide and various borates.

A comprehensive description of commonly used flame retardants is found, for example, in D. L. Buszard: “Polymer flammability—mechanisms of achieving flame retardance” in G. Cox, G. Stevens (Eds.) “Fundamental Aspects of Polymer Flammability”, IOP Short Meetings Series No. 4, 1987, London.

Examples of halogen-containing flame retardants which may be used for the purposes of the present invention include chloroparaffins, hexabromobenzene, brominated diphenyl ethers and other bromine compounds, such as decabromodiphenyl oxide, pentabromodiphenyl oxide, decabromodiphenyl ether, octabromodiphenyl ether, tribromophenyl tribromopropyl ether, 2,2-bis[4-(2,3-dibromopropoxy)-3,5-dibromophenyl]propane and hexabromocyclododecane.

Particular preference is given here to the aliphatic flame retardants, especially hexabromocyclododecane.

Suitable antimony-containing flame retardants include antimony trioxide, and also colloidal antimony pentoxide. For the purposes of the present invention, particular preference is given to the combination of antimony trioxide with halogen-containing flame retardants.

Examples of phosphorus-containing flame retardants include red phosphorus, phosphates, phosphites, phosphonates, resorcinol bis(diphenylphosphate), tricresyl phosphate and the like. According to the invention, it is also possible to use halogenated organic phosphorus compounds such as tris(2,3-dibromopropyl) phosphate or tris(2-bromo-4-methylphenyl) phosphate.

According to the invention, it is also possible to use the following other inorganic flame retardants: aluminum oxide hydrates, aluminum hydroxide, basic aluminum oxalate, magnesium hydroxide, coated magnesium oxide, zinc sulfide, metal borates, such as zinc borate, calcium borate or barium metaborate, and expandable graphite.

The present invention may be used for producing any type of hollow plastic article in which increased fire resistance is required and/or is desirable. The present invention is particularly suitable for hollow plastic articles for the storage and transport of combustible liquid. Examples of these are: fuel canisters, fuel tanks for the storage and transport of heating oil, diesel and the like, fuel tanks and tanks for gasoline or diesel fuels in motor vehicles, transport containers on utility vehicles, for example for crop sprays, solvent containers, solvent (receiver) tanks, plastic bottles, etc.

The examples below are intended to illustrate the invention but not to limit the scope of protection.

### EXAMPLES 1 TO 3

To study the fire performance of coextrusion blow molded hollow articles, polyethylene was used to produce plastic fuel tanks whose structure had 6 layers—in the direction from inside to outside HDPE (33.1%)/tie layer material (2%)/barrier polymer (3.7%)/tie layer material (2%)/regrind layer (44.1%)/HDPE (15.1%) (all data in percent by weight, based on the tank). The barrier polymer used was EVAL® EP F 101 A, and the tie layer material was Admer® GT5E. In comparative Example 1, LUPOLEN® 4261 AG is used as base material. In comparative Example 2, a polymer is used which has the combination of properties of the patent specification EP 0 645 400 B1. Finally, in inventive Example 3 a tank based on LUPOLEN® 4261 AG is produced and CONSTAB FR 7062 DL flame retardant was added to the regrind layer to give a constant content of 10% of the CONSTAB FR 7062 DL masterbatch in the regrind. Table 1 below gives the data for the materials of the two different polyethylene grades. The PFTs were subjected to various mechanical tests, the results of which are given in Table 2.

The bursting pressure was tested at room temperature and with a linear pressure-rise rate of 0.5 bar/min.

For the drop test, the tanks were completely filled with a water/glycol mixture and cooled to −40° C. The cold tanks were allowed to fall from a height of 6 m, from a total of four different drop positions. Each drop position was tested twice, and a total of eight tanks were therefore tested for each tank series. For evaluation, the number of drops which did not lead to damage was related to the maximum possible number of drops (in this case 8) and given as a percentage.

The method for determining fire resistance was based on the specification in ECE R 34 Appendix 5. Here, the tank is installed into the actual bodywork of a motor vehicle, half filled with water and exposed to two phases of flame application using burning fuel. Fire resistance is determined by lengthening the time of the first flame-application phase, the direct flame application, in steps until a hole was produced in the tank wall. The duration of the second flame-application phase was constant at 60 sec.

The examples presented here show that no improvement in fire resistance is achievable with the material described in EP 0 645 400 B1. In contrast, adding 10% by weight of flame retardant to the regrind layer, i.e. based on the total weight of the tank an addition of only 4.4%, increased the fire resistance of the tank by 14%. The mechanical strength of the tank remains essentially at the level of the corresponding tank without flame retardant from Example 1.

TABLE 1

| | | | Experimental |
|---|---|---|---|
| | | LUPOLEN ® | material |
| Property | Unit | 4261 AG | as per EP 645 400 |
| Comonomer content | % | <1 | <1 |
| Density | g/ccm | 0.945 | 0.954 |
| MFR 190° C./21.6 kg | g/10 min | 6 | 3.7 |
| η | dl/g | 3.7 | 4.7 |
| R* | | 2.39 | 2.56 |
| HRI-IZOD (−30° C.)* | J | 0.68 | 1.13 |

*Measurements as in data given in EP 645 400 B1

TABLE 2

| Test | PFT Example 1 | PFT Example 2 | PFT Example 3 |
|---|---|---|---|
| Bursting pressure | 3.75 bar | 4.55 bar | 3.4 bar |
| 6 m drop test | 75% | 75% | 62.5% |
| (−40° C.) | | | |
| Fire test | 72 + 60 sec | 66 + 60 sec | 90 + 60 sec |

We claim:

1. A hollow plastic article with increased fire resistance, comprising at least one opening, wherein the structure of the hollow plastic article has one or more layers and comprises at least one layer made from polymeric material and having flame retardants.

2. A hollow plastic article as claimed in claim 1, wherein the structure of the hollow plastic article has two or more layers, preferably comprising a base layer, regrind layer, tie layer and/or barrier layer, where flame retardants are preferably present in one or more of the outer layers, particularly preferably in a regrind layer.

3. A hollow plastic article as claimed in claim 1 or 2, wherein the polymeric material of the layers comprises polyethylene, polypropylene, polyvinyl chloride, polyamide, polyketone, polyester and/or mixtures of these.

4. A hollow plastic article as claimed in any one of the preceding claims, wherein the hollow article comprises one or more regrind layers which are composed of at least 50% of the material from which the innermost layer of the hollow article has been formed.

5. A hollow plastic article as claimed in any one of the preceding claims, wherein the flame retardants used are halogen-containing, phosphorus-containing, organic or inorganic, preferably aluminum hydroxide, magnesium hydroxide, borates and/or antimony-containing flame retardants, particularly preferably combinations of antimony trioxide with halogen-containing organic flame retardants.

6. A hollow plastic article as claimed in any one of the preceding claims, which has, based on the total weight of the hollow article, from 1 to 25% by weight, preferably from 1 to 10% by weight, particularly preferably from 2 to 6% by weight, of flame retardants.

7. A hollow plastic article as claimed in any one of the preceding claims, wherein the flame retardant is introduced exclusively, or in a higher concentration, into individual regions and/or zones of the hollow plastic article.

8. A hollow plastic article as claimed in any one of the preceding claims, comprising, in the direction from the inside to the outside:
a layer made from HDPE with a thickness of from 10 to 40%,
a tie layer with a thickness of from 1 to 5%,
a barrier polymer layer with a thickness of from 1 to 10%,
a tie layer with a thickness of from 1 to 5%,
a regrind layer with a thickness of from 10 to 82%,
a layer made from HDPE with a thickness of from 5 to 30%,
based in each case on the total thickness of the container wall.

9. The use of the hollow plastic article as claimed in any one of the preceding claims as a plastic fuel tank in motor vehicles, a fuel canister, a plastic tank for storage and transport of heating oil, diesel or the like, a transport container on utility vehicles, for example for crop sprays, a solvent container, a solvent tank, a plastic bottle or the like.

10. A process for producing a hollow plastic article with increased fire reistance, as claimed in any one of claims 1 to 8, which comprises molding the hollow plastic article from a polymeric base layer and, if desired, other layers, preferably comprising a regrind layer, a tie layer and/or a barrier layer, where flame retardant is added to at least one layer, preferably the regrind layer, and the hollow plastic article is subjected, if desired, to a heat treatment at from 60 to 135° C.

11. A process as claimed in claim 10, wherein the duration of the heat treatment is from 0.25 to 30 hours.

12. A process as claimed in claim 10 or 11, wherein the controlled introduction of flame retardant into individual regions and/or zones of the hollow plastic article takes place by way of visibility-strip extrusion, sequential coextrusion and/or the like.

13. A process as claimed in any one of claims 10 to 12, wherein the partial introduction of flame retardants into one layer of the multilayer composite takes place by way of blow molding using additional extruders, in a manner similar to visibility-strip extrusion and/or to sequential coextrusion.
